(19) United States
(12) Patent Application Publication
(10) Pub. No.: US 2005/0285947 A1
(43) Pub. Date: Dec. 29, 2005

(54) Real-time stabilization

(76) Inventors: Gene Arthur Grindstaff, Decatur, AL (US); Sheila G. Whitaker, Gurley, AL (US); Susan Heath Calvin Fletcher, Huntsville, AL (US)

Correspondence Address: John J. Stickevers;Bromberg & Sunstein LLP, 125 Summer Street, Boston, MA, 02110-1618, US

(21) Appl. No.: 10/872,767

(22) Filed: Jun. 21, 2004

(51) Int. Cl. H04N 5/228

(52) U.S. Cl. 348/208.4

(57) ABSTRACT

In a first embodiment of the invention, there is provided a method for structuring digital video images in a computer system. The digital video images are capable of being displayed on a display device and contain addressable digital data that is addressable with respect to a reference point on the display device. The method may be embodied in computer code on a computer readable medium which is executed by a processor within the computer system. The computer code removes motion from a digital video image stream. By removing motion from the digital image stream, additional information and details can be observed which are spread out over multiple images when the images are displayed in sequence. The method begins by obtaining a first digital video image and a second digital video image. A subsection is defined within the first digital image at an addressable location relative to the reference point. A subsection of the second digital image is selected which has the same addressable location as the subsection from the first digital image. The subsection of the second digital video image is shifted in a predetermined direction. After the region is shifted, an error value is calculated based upon a comparison of the subsection of the first digital image and the shifted subsection of the second digital video image. If the error is below a predetermined threshold, the digital data of the second digital video image is readdressed such that the data of the newly defined subsection would overlay the subsection from the first digital video image if displayed on a display device.

### TECHNICAL FIELD AND BACKGROUND ART

The present invention relates to image stabilization of recorded material. The recorded material is image stabilized in order to ascertain more information about an object moving in the image. During the capture of video, an object that is being captured may be moving and thus the captured image appears either blurry or the image is jittery. As a result, information concerning the moving object is spread out over several frames of video which cannot be perceived by a viewer of the video. It is known in the art to perform video stabilization through mechanical means and by digital signal processing, however the techniques are complicated and often are based upon motion estimation and vector analysis.

### SUMMARY OF THE INVENTION

In a first embodiment of the invention, there is provided a method for structuring digital video images in a computer system. The digital video images are capable of being displayed on a display device and contain addressable digital data that is addressable with respect to a reference point on the display device. The method may be embodied in computer code on a computer readable medium which is executed by a processor within the computer system. The computer code removes motion from a digital video image stream. By removing motion from the digital image stream, additional information and details can be observed which are spread out over multiple images when the images are displayed in sequence. Similarly by removing motion from multiple images, the images can be combined using digital signal processing techniques to create an image having more information than any single image.

The method begins by obtaining a first digital video image and a second digital video image. The images may be obtained from memory or through an I/O port into a processor executing the computer code. A subsection is defined within the first digital image at an addressable location relative to the reference point. The subsection may be defined by graphically selecting the subsection using a pointing device or the selection of the region for the subsection may be predetermined and automatically selected. A subsection of the second digital image is selected which has the same addressable location as the subsection from the first digital image. The term addressable refers to the address on the graphical display device. The subsection of the second digital video image is expanded in a predetermined direction, such as expanding the width of a rectangular subsection to the right. After the region is expanded, an error value is calculated based upon a comparison of the subsection of the first digital image and the expanded subsection of the second digital video image. The error value defines the amount of correlation that the data of the region from the second digital video image and the data from the region of the first digital video image exhibit. The subsection of the second digital video image is newly defined to include digital data in the direction of the expansion. In other embodiments, the region is shifted in the second digital video image and the subsection from the first digital video image and the subsection of the shifted region of the second digital video image are compared and an error value is determined. If the error is below a predetermined threshold, the digital data of the second digital video image is readdressed such that the data of the newly defined subsection would overlay the subsection from the first digital video image if displayed on a display device. The digital data is repositioned in the direction opposite that the second digital image was expanded. If the region is shifted rather than expanded, the image data from the second region is readdressed such that the image data will overlay the image data from the image data from the originally selected region of the first image.

In another embodiment, the subsection of the second digital video image is expanded in a second direction that is different from the first direction of expansion. A second error value is calculated based upon a comparison of the subsection from the first digital image and the subsection of the second digital video image that has been expanded in the second direction. The first and the second error values are compared and the lower error value is determined. The lower error value indicates that there is more correlation. A new subsection is selected from the second digital video image including digital data in the direction of the expansion associated with the lower error value. In one embodiment, the process of expanding the subsection and determining an error value is iteratively performed in each of the four cardinal directions. The error values are then all compared and the lowest error value is selected. A new subsection in the second digital video image is selected which is different from the position of the original subsection and is off set from the original position in the direction that the subsection was expanded that had the lowest error value. The lowest error value is then compared to a predetermined threshold. If the lowest error is below the predetermined threshold, the data of the second digital video image is readdressed. The second digital video image is readdressed such that the current subsection of the second digital video image if displayed on a display device would overlay on top of the subsection from the first digital video image.

The process may be iteratively repeated by shifting the subsection, such that data is included in the direction of the expansion for the lowest error value, expanding the subsection in each of plurality of directions, determining error values for each of the directions until the lowest error value falls below the predetermined threshold or the steps are performed a predetermined number of times. If the lowest error value does not fall below the predetermined threshold, a new subsection of the first digital video image is selected and the process is performed again.

In other embodiments the subsection is not expanded in a direction, rather the region is moved in a direction and the subsections are compared. As such, the newly defined subsection has the same number of data values as that of the original subsection unlike in the embodiment in which the subsection is expanded in which the expanded subsection includes the original data values and new data values, and thus, has more data values than the original subsection. After the region has been shifted in each of the four cardinal directions, an error value is calculated and the region of the second image is set to be the region with the lowest possible error. The process continues with the new region of the second image being shifted in each of the four cardinal directions and an error value being determined. In certain embodiments, the size of the shifts is decreased after the region of the second image is set. Thus the search spirals in on the subsection of the second image which shares the greatest amount of data with the originally selected region of the first image. In other embodiments, the process continues until all of the images in the image stream are processed. In this embodiment, the subsection of the first image is compared to the subsection of the second image. Once motion has been accounted for between these images, the subsection of the second image is compared to subsections from the third image until the third image is readdressed to compensate for motion. This continues for the entire video image stream.

Further, it should be noted that the directions of expansion and shifting of the subsections and regions can be directions other than the cardinal direction and the shapes of the subsections and regions may be shapes other than square or rectangular. Further, although the subsections and regions preferably have the same shape and therefore the same number of data values, this need not be the case.

### BRIEF DESCRIPTION OF THE DRAWINGS

The foregoing features of the invention will be more readily understood by reference to the following detailed description, taken with reference to the accompanying drawings, in which:

FIG. 1A is diagram showing two digital video image frames;

FIG. 1B is a diagram showing the region selected from the first frame and the region selected from the second frame;

FIG. 1C-F shows the region and subsection of the second frame being expanded in each of the four cardinal directions;

FIG. 2A-C is a flow chart showing one embodiment of the present invention;

FIG. 2A compares subset areas of the first and second image to determine an error value;

FIG. 2B extends upon FIG. 2A and causes a new area in the second image to be compared to the area in the first image;

FIG. 2C shows the iterative process for determining a region prior to repositioning the digital data of the second digital video image;

FIG. 3 is a flow chart showing an alternative embodiment of the present invention in which the subsection is expanded;

FIG. 4 is a flow chart showing an alternative embodiment of the present invention in which regions are shifted; and

FIG. 5 is a flow chart showing another embodiment of the present invention.

### DETAILED DESCRIPTION OF SPECIFIC EMBODIMENTS

Definitions. As used in this description and the accompanying claims, the following terms shall have the meanings indicated, unless the context otherwise requires: the term “frame” as used herein applies to both digital video frames and digital video fields. A frame of video can be represented as two video fields wherein the odd lines of the frame represent a first field and the even lines represent a second field. The term “subsection” of an image is an area of an image when displayed on a display device and includes the pixel data from that area. The area is less than the entire image. The term “region” or “search area” refers to an area of an image that is used to define a subsection, but does not include the pixel data. The term “error value” is indicative of the amount of correlation that a first set of data has to a second set of data. As used herein, if a first error value is less than a second error value the data sets that are compared in calculating the first error value exhibit a greater amount of correlation than the data sets that are used to calculate the second error value.

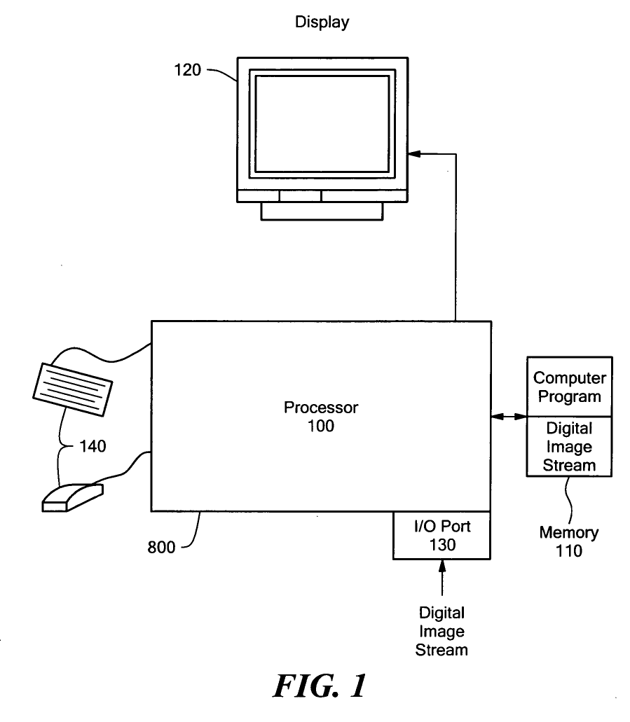

FIG. 1 shows a computer system for use with a digital video image stream. The computer system includes a processor 100 and associated memory 110. The processor 100 retrieves a computer program from memory 120 and executes the steps of the computer program. The computer program allows a digital image stream to be processed in order to remove motion from the sequence of images that comprise the digital image stream. The digital video image stream is either imported into the computer system through a port 130 and provided to the processor or is stored in the associated memory 110 and requested from memory 110 by the processor 100. The data that makes up the digital video image is pixel data. Each pixel represents a different location on a display device. For example a display device may be capable of displaying 800×600 pixels. Each pixel has an addressable location that is defined by a coordinate system. The coordinate system has a reference point such that each image can be displayed on the display device 130. The pixel data for a video image that is to be displayed at a given moment in time is defined as a video frame. The reference point and the coordinate system are consistently used for each of the video frames. The video frames/images can be displayed on the display device 130 and a user may use an input device 140 to select a region of an image defining a subsection of the image data for future processing as explained below.

FIG. 1A is diagram showing two digital video image frames from the digital image stream. The first image is a reference image. A user either selects a region of the reference image or the computer system automatically selects a region of the image. The region can be defined by a location on a display device which is associated with an address based on the coordinate system. FIG. 1B shows the first and second video frame side by side. After the region is selected in the first frame pixel data identifying the subsection is determined. The computer system implementing the computer code selects the same region in the second frame along with the corresponding pixel data defining the subsection of the second image. As such, the same addressing information for the first frame is used for the second frame.

The computer program then expands the subsection of the second frame. For example, as shown in FIG. 1C, the second subsection is expanded in an upward direction. The total number of pixels within the selected region is thereby increased. So if the original region included 100 pixels×100 pixels, the new region may be 120 pixels by 100 pixels. The computer program then compares the subsection in the first frame to the subsection defined by the expanded region from the second frame to determine an error between the two subsections. The method used to compare the subsections may be the average color value for the regions or a comparison of pixel by pixel values to determine the greatest number of matches. Other techniques may also be used that compare pixel values. The computer system then expands the original region in a second direction as shown in FIG. 1B. In FIG. 1B the original region from the second frame is expanded to the right defining a new subsection. So that in the example, the region would be 100 pixels by 120 pixels. Again the computer system compares the data from the first region in the first frame with the expanded region in the second frame to determine an error value. This process is then performed in a third and a fourth direction as shown in FIGS. 1E and 1F so that an error value is collected for each expansion of the region in one of the cardinal directions. It could be imagined that other directions or expansions of the regions are selected in order to expand. For example the regions may be at 45 degrees to the cardinal axes or the regions may not be uniform in shape. For example, the shape of the expansion may be shaped much like that of an arrow head. The expanded region having data within the region with the least amount of error is selected. As previously mentioned, the lower the error value is the greater the correlation between the data within the regions from the first and the second images.

The region in the second frame is then moved in the direction of the lowest error (so that the new subsection in the second image would have 100×100 pixels in the provided example) and the process is repeated wherein the subsection from the first frame is then compared with expanded versions of the newly defined subsection in the second frame.

This process continues until the amount of error either falls below a threshold or the process stops if the error values fail to decrease as the expanded regions are compared. By redefining the region in the second image and moving and comparing the error in each of the cardinal directions, the direction of movement can be readily found. Once the subsection in the second frame is found that has the least amount of error in comparison to the subsection of the first image, the addresses of the pixels within the second image are readdressed such that the subsection of the first image and the subsection in the second image will overlap if simultaneously displayed on a display device.

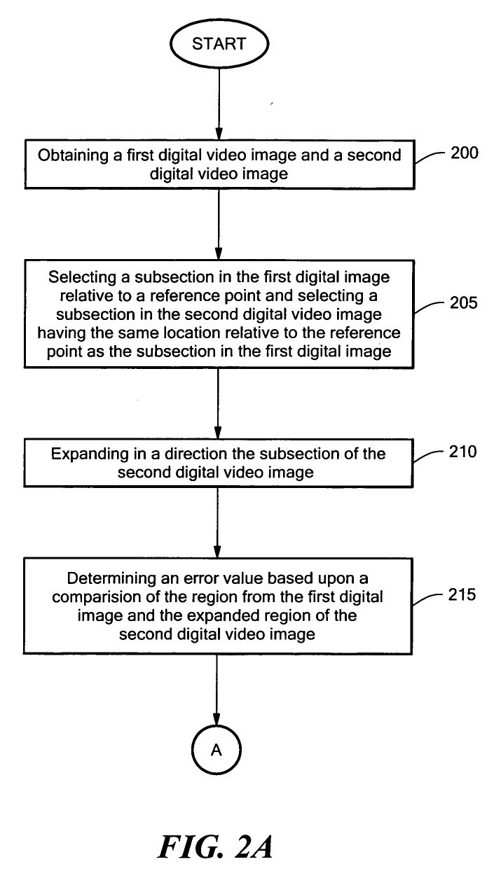

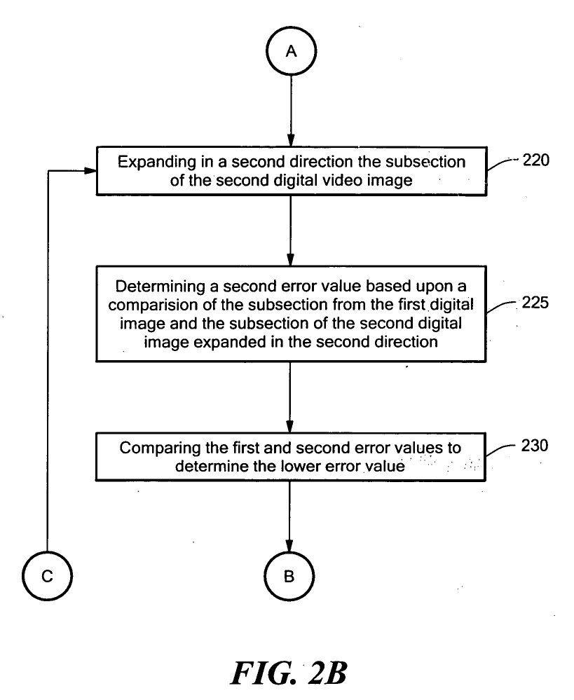

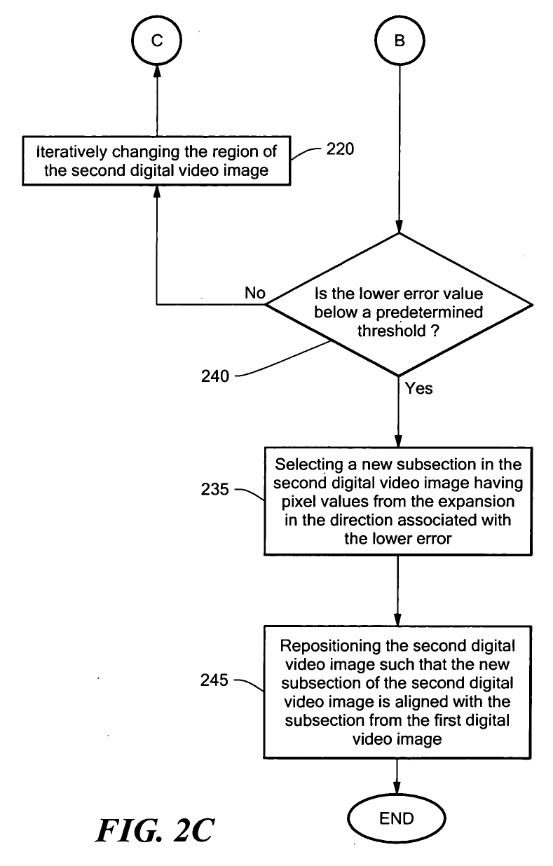

One embodiment of the methodology performed by the processor in conjunction with the computer code from memory is shown in FIG. 2A. First a first digital video image and a second digital video image are obtained (200). The digital video image may be received in streaming fashion from an I/O port electrically coupled to the processor or the digital video images may be retrieved from memory. A region is selected in the first digital video image (205). The region is defined by the address location of the region if displayed on a display device. This step can require that a user select the region as the image is displayed on a display device with an input device. The user may use the input device, such as a mouse to select the region by encircling the region and thereby selecting the digital data within the region. Computer code allowing a user to select a region of an image is known to those of ordinary skill in the art. The computer code may also automatically select the region and the accompanying data. For example, the computer code may select a region at the center of the image or any other part of the image. The computer program then selects the same region within the second digital video image wherein the region is defined by the addresses of the pixel data.

The subsection of the second digital video image is expanded (210) so that the subsection includes more data. The expanded region encompasses more pixel values or data points than that of the originally selected region of the second digital video image as shown in FIG. 1C for example. An error value is determined based upon a comparison of the subsection from the first digital image and the expanded subsection of the second digital video image (215). The error value can be calculated based upon the pixel value information in the subsection from the first image and the expanded subsection from the second image. The pixel data may be compared on a pixel by pixel basis looking for a match for the color values within the pixels. So the error value would be the percentage of mismatch between the first subsection and the expanded second subsection. As such the error value is inversely indicative of correlation. If movement occurs in the direction that the subsection of the second image is expanded, it is expected that there will be at least some pixel matches. It should be understood that the error value or the corresponding match value could be used for comparison without deviating from the invention. A match value would be the percentage of pixels/colors that match rather than the amount that do not match.

Other comparison techniques may include determining an average color value or values for the subsection and then determining the error with respect to the average color values. In general, pixel values have one or more color values associated with the pixel. In comparing subsections, average values could be calculated for each of the colors, for example, red, green, and blue and then a percentage error from each of these colors could be determined. In another variation, the color values could be transformed into grey scale values and compared either on a pixel by pixel basis or based on the average grey scale vale.

In other embodiments, the region defining the data of the subsection of the second digital video image is not expanded, but rather the region is moved in a direction and then a direct comparison between the subsection from the first video image and the new subsection from the second video image are compared.

After an error value or a corresponding match value has been determined, the original region from the second image is expanded in a direction other than that from step 210 for example as shown in FIG. 1D (220). The first subsection from the first image is then compared to the expanded subsection in the second video image. An error value is determined between the subsection from the first image and the expanded subsection from the second image. The error value is calculated using the same technique that was used in comparing the first subsection with the expanded subsection of the second image expanded in the first direction.

It should be understood by one of ordinary skill in the art that various filters or compensation techniques may be used prior to comparison. For example, the average intensity value for the pixels in the subsection of the first image and the average intensity value for the pixel values of the subsection of the second image are calculated. The average intensity value is subtracted from each of the pixel intensity values. This step normalizes the values accounting for any changes in brightness between frames, such as sudden light flashes. Thus, only the absolute value of the variation about the median of the two images is compared. This normalization may also be performed in any one of a number of ways known in the art, including using the RMS value as opposed to the average intensity for the user selected area.

The processor then compares the first and second error values (230). Depending on how the error value is defined, the lower error will be selected. This is equivalent to the second expanded subsection sharing the greater amount of information with the first subsection.

The processor then checks to see if the lower error value is less than a predetermined threshold (240). If the lower error value is less than the predetermined threshold, the second image is repositioned. A new region for the second image is first defined by moving the region in the direction of the expansion (235). For example if the original subsection was 100×100 pixels beginning at address (10, 15) wherein 10 is in the x direction and 15 is in the y direction, then the new subsection would be 100×100 pixels beginning at (20,15) if the lower error value was found when the region was expanded in the positive x direction. The entire second image is then readdressed such that the first subsection and the new subsection from the second image share the same address. By readdressing the second image, motion will be removed from the video image stream when the first image is shown followed by the second image.

If the lower error value is not below the predetermined threshold then the method returns to step 220 at which the subsection of the second image is again expanded in a direction that is different from the directions that the second subsection has already been expanded. For example, if the image has been expanded as shown in FIGS. 1C and 1D already, the subsection may be expanded as shown in FIG. 1E.

It should be understood that a number of the steps described can be performed in another order without deviating from the scope of this invention. For example, an error value may be determined for each expansion of the subsection in the four cardinal directions. The error values may be compared and based upon the lowest error level, the subsection of the second image may be repositioned in the direction of the lowest error value. As before, the repositioned second subsection would maintain the same dimensions as the first subsection in the first image. This process may continue until the error level falls below a predetermined threshold, the error levels stop decreasing, or the second image is repositioned a predetermined number of times, for example 20 times. If the second image is repositioned a certain number of times, the processor may cause a new subsection to be selected and the process would begin again. If the error value falls below the predetermined threshold, then the second image would be readdressed such that the first and the second region would be overlapping if simultaneously displayed on a display device. The process continues with a comparison between a subsection in the third image and the subsection in the second image. This methodology repeats until all images are processed and at the majority of the images are readdressed.

By readdressing the images, motion within the images would be compensated for. For example, if a person was moving across the screen and their facial features were hard to identify in any one image in the video, the person's face would be more recognizable if the motion is removed from the video sequence and the each image is overlaid such that the person's face remains still. More information is provided by all of the images than with one individual image. Image enhancement techniques could then be used with the images to create a single still image which included the additional information.

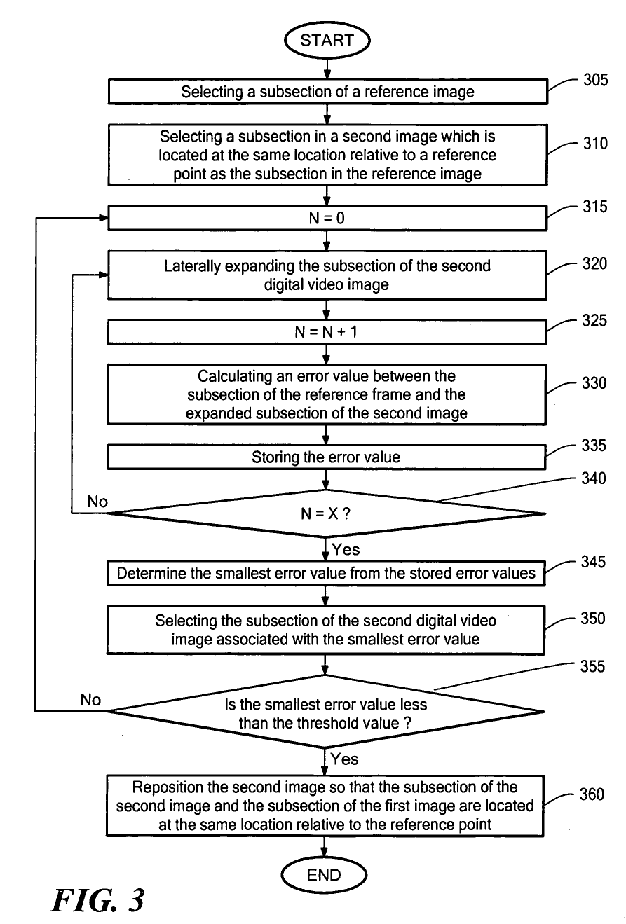

FIG. 3 shows a slightly different variation of the disclosed method. First a subsection of a reference image is selected. For example, a region corresponding to the subsection may be chosen by a user selecting a region of the video image on a graphical display or the processor may execute computer code which provides the address of the region (305). A subsection of a second image, which is the current image, is then selected. The subsection of the second image has the same address(es) as that of the subsection from the reference image, but contains the associated data with the second image (310). A counter, N, is set to a value of zero (315). The counter is used to count the number of different directions that the subsection of the current image is expanded. The subsection of the current image is then expanded in a first direction, such that it includes more pixel information as compared to the unexpanded subsection. The counter is incremented and then an error value is calculated. The error value measures either the amount of non-shared information between the subsection from the reference image and the expanded subsection of the current image. As was previously stated, the error value may also represent the amount of shared information. The more information that is shared between the subsections, the greater the likelihood that movement occurred in the direction that the subsection of the current image was expanded. The error value is then stored for later retrieval. The processor checks to see if the counter has reached a predetermined threshold number. For example, if the subsection is being expanded in the cardinal directions X would be equal to four. In other embodiments, X could be any value greater than two, such that a plurality of error values are saved for comparison.

The error values are retrieved and compared. The computer program executing on the processor determines the lowest error value which represents the greatest amount of shared information between the reference subsection and the expanded subsection of the current image. The originally selected region in the current image is then shifted in the direction of the expansion. As explained above, if the lowest error is found with the expansion in the positive Y direction (X-Y coordinate system) then the region will be moved in the positive Y direction while still maintaining the same proportional shape as the region in the reference image. As such, if the original unexpanded region of the current image is 10×10 pixels, the shifted region will also be 10×10 pixels. The subsection of the shifted region is then used for future comparisons. The lowest error value is then compared to a threshold value. If the error value is less than the threshold value, the current image is repositioned so that the address of the pixels within subsection of the reference image and the pixels within the shifted subsection of the current image share the same addresses. This can be readily accomplished by readdressing the pixel values of the second image. The threshold value is set high and is used to determine that subsections match and that no additional searching is necessary.

If the lowest error value does not fall below the threshold, the process continues and the counter is reset. The subsection of the second image is expanded in each of the directions and an error value is calculated comparing the reference image subsection with each of the expanded regions. This process continues until the error value falls below the threshold. In some embodiments, an additional step may be included. This additional step is the inclusion of a counter which will cause the processor to stop shifting the subsection region of the current image if the counter reaches a pre-determined number of tries or if the lowest error value does not continue to decrease.

After the current image is re-addressed, the current image becomes the reference image and the next image within the image stream is the current image. The subsection of the current image is then expanded and compared to the subsection of the reference image as before. This process continues through all of the images within the image stream. Thus, the images are readdressed, and when displayed on a display device in order, movement is removed or reduced from the sequence.

This process can be performed in real-time on an image stream due to the limited number of comparisons and calculations that need to be made. The images recorded by an analog video camera can be converted into a digital image stream and the process can be used or the digital image stream from a digital video camera can be provided to the processor and motion can be removed from the resulting image stream.

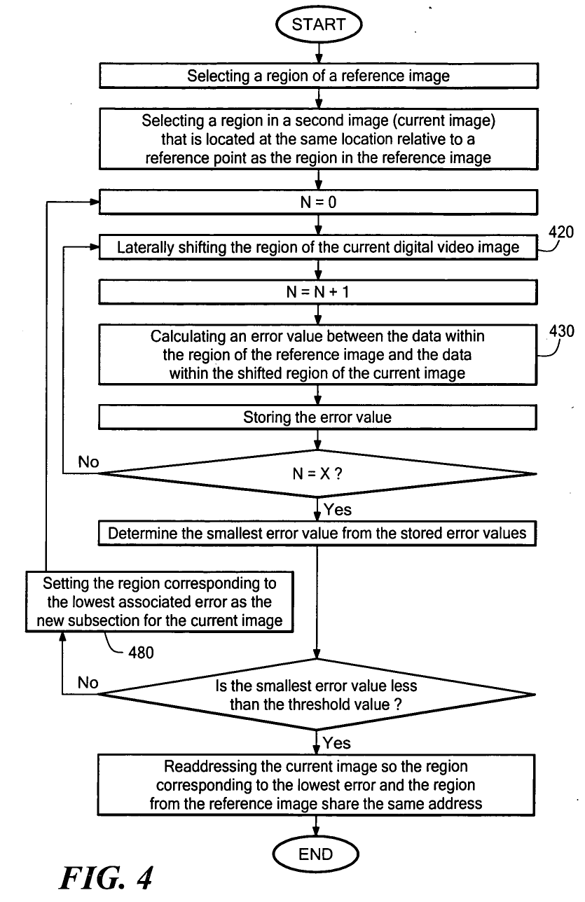

In another embodiment as shown in the flow chart of FIG. 4, the subsection of the current image is not expanded, rather the region defining the subsection is shifted. For, example, if the original subsection is a 20×20 pixel subsection, this 20×20 region will be shifted a number of pixels in a predetermined direction such as one of the four cardinal directions. This is performed in step 420. As such, not all of the original pixels within the original subsection are included in this shifted region. An error value is then calculated between data from the reference region and the data from the shifted region of the current image 430. The shifted region of the current image with the lowest error is selected and the corresponding subsection is used for future comparisons with the subsection of the reference image 480. It should be understood that although the subsection from the reference image and the subsection of the current image have areas that are the same in terms of the number of pixels within the region, the size of the regions that are being compared need not be the same. For example, the subsection from the reference image may be 100×100 pixels whereas the subsection of the current image may have 120×120 pixels. The process is continued and the comparison between data from the shifted region of the current image and the region from the reference image is performed either until the lowest error value is less than a threshold value or a predetermined number of shifts have occurred.

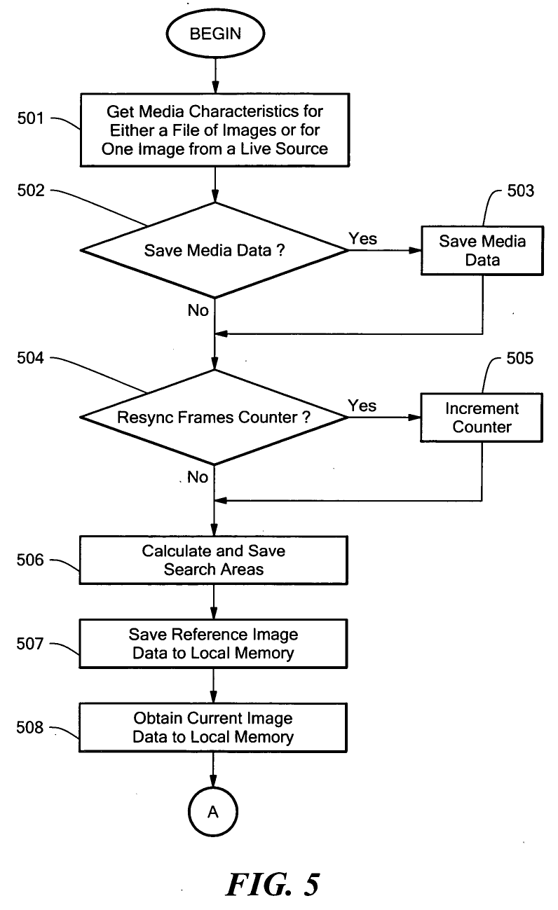

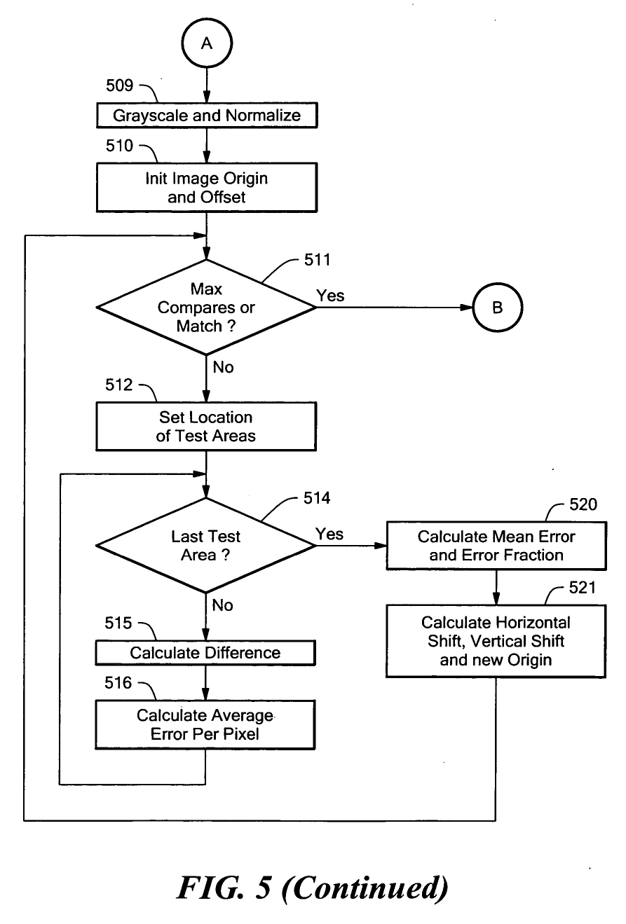

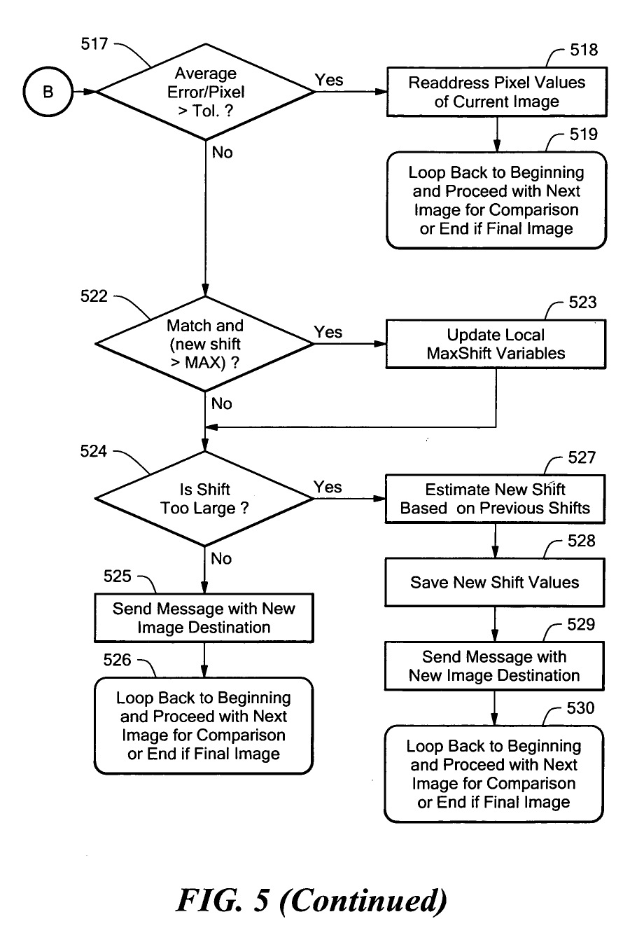

FIG. 5 shows a flow chart of another embodiment wherein the flow chart shows a more detailed embodiment of FIG. 4. It should be noted that each of the flow charts can represent computer code and the executable steps performed by software operating on a processor. The searching mechanism of FIG. 5 operates in a spiral pattern, comparing a region in a reference image to a region in a current image which is shifted for each comparison in one of the four cardinal directions by a set number of pixels. The lowest per pixel error between the shifted region in the current frame and that of the reference frame is determined. The region is then recentered for the current image to the position of the shifted region with the lowest per pixel error. The program then searches again in each of the four cardinal directions by a number of pixels that is less than that previous number. In such a fashion the search routine spirals in on the area having the least amount of error.

The process operates in the following manner. First either a media file or image from a live source is received into the processor. The media file or live source contains or produces one or more images that are composed of data. Each image may be made up of a plurality of pixel data. Media characteristics are obtained for the data of the live source or file 501. For example, for a bit map file, the processor in conjunction with the software will ascertain the color format of the data. The data may be in any one of a number of formats such as RGB and YUV color components. The color components are then converted to RGB for further processing. Either a single frame/field forming an image may be processed or all of the images within a file may be processed. Although the components are converted to RGB color components, any other color format may be used by the process without deviating from the invention. The conversion is performed so that the program can operate on a media file that is in any one of a number of formats while internally the methods and code are written for processing only a single format.

The program then inquires to the user whether the converted data should be saved 502. If the user indicates that the data should be saved, the media data is saved to associated memory of the processor 503. If the user decides not to save the media data, the program then checks to see if the frame counter needs to be re-synced 504. For example, if a live source is being processed, images may be dropped during processing. The program then checks the data to identify if any frames have been dropped and increments the counter accordingly if frames have been dropped 505.

The program then provides an interface that allows the user to select the search area or the system is preprogrammed with a default search area 506. For example, if the system defaults to a search area the area may include data corresponding to the center 50% of an image when displayed on a display device. The user may be provided with the ability to select the region by using an input device and selecting a region of a display screen using the input device. For example, a user may use a mouse to click and drag the mouse to define the region on the screen, such as a 100 pixel×100 pixel square. The user may select any area of an image as the search region. The processor then saves the first image from either the file or the live source to local memory 507 which will be referred to as the reference image. The program then obtains the next image which is the current image and stores the current image in local memory to use in the comparison to the subsection of the reference image 508. The program may then allow a user to select the search area.

The images (reference and current image) undergo a normalization process wherein the color image is first converted to a grayscale image 509. After the image is converted to grayscale, the average intensity value is calculated for the image and then that value is subtracted from each pixel value to normalize the image for lighting effects. The origin of the initial image is stored in memory along with the offset to the search area 510. This defines the start point for the search. The current image is retrieved. The program then checks to see if the maximum number of comparisons has been done 511. The maximum number of comparisons is a variable number that may be automatically set or user defined. If the answer is no, and the counter has not reached the number of maximum compares the location of the search area is updated 512. The search is conducted such that the data within the search area of the reference frame is compared to data of the search area of the current frame. The search area is moved by a number of pixels in one of the four cardinal directions. For example, assuming that the search area is a square of 100 by 100 pixels, the search area may be moved by 10 pixels to the right. A comparison is then made between the pixels in the 100 by 100 square from the reference frame and from the current frame. The system then determines if this is the last search area 514. The system will perform a search in each of the cardinal directions, and thus, a counter will be incremented between 1 and 4. If the program has not searched in each of the four cardinal directions, a difference is determined between the pixel values in the reference frame and the current frame 515. The percentage of error is then calculated and may be determined on a pixel by pixel basis or may be determined in any one of a number of other ways to calculate the error between two regions 516. The error may be for the entire region as a whole or may be an average error per pixel. The program then continues to loop until all four directions have been searched. The program determines the lowest error among the four cardinal directions 520. A new origin is then determined 521. The number of pixels that the search area is shifted (offset) can also be varied. In one embodiment, each time through the search process (511-521), the offsets are decreased in size. For example, searches may be performed in where the search area is offset 20 pixels the first time through, wherein the offsets may be reduced to 10 pixels the second time through the loop and to 5 pixels the third time through the loop. If there is a reduction as just described, the program spirals in on the subsection of the current image having the lowest error per pixel when compared to the subsection of the reference image until the maximum number of compares occurs or an exact match is found between the pixels within the subsection of the current image and the search area of the reference image.

The program loops back and determines if the maximum number of compares have occurred or if a match has been found at step 511. The maximum number of compares is a set number. If the maximum number of compares is reached, the average error/pixel for the last comparison of the reference image and current image is compared to a tolerance value 517. If the average error/pixel is greater than the tolerance, then the image data is readdressed such that the location of the search area from the reference frame and the shifted search area from the current frame having the lowest error are aligned 518. It should be understood by one of ordinary skill in the art when reference is made to the fact that the average error/pixel is greater than the tolerance, this implies that there is a greater match between the data within the search area of the reference image and the current image than the minimum as defined by the tolerance. It should also be understood by one of ordinary skill that if a match occurs that the average error/pixel is greater than the tolerance. The program can then loop back to the beginning. The data within the search area of the next frame is then compared to the data within the search area of the reference frame. In certain embodiments, the current frame is updated as the reference frame and the shifted search area for the current frame becomes the new search area for the next frame.

If the average error/pixel is not greater than the tolerance then the program shifts the image and checks to see if the amount that the image was shifted is so great that an error occurs 522. For example, at the edges of the image the search area may be shifted such that a portion of the search area does not contain any data and is off of the image. If this is the case, the local maximum shift value is reduced 523. The system then checks to see if the shift is still too large and does not contain data 524, if the answer is no, the offsets are updated 525. If the answer is yes, then the system estimates a new shift based upon previous shifts for previous images 527. For example, the amount of shifting of the pixel values may be based upon the average shifting of the previous three images. The shift values are saved to memory 528 for future use. The pixels of the current image are readdressed such that the current image is shifted a number of pixels based upon the previous shifts 529. For example, if the data of the previous three images had each been shifted 8 pixels to the right and readdressed to that location, the program would do the same for the current image. The program will then return to the beginning. The user will be notified that a match could not be found and that an estimate was performed before continuing on with the next image either from the file or from the live source. The user can then decide 1) if a new search region should be selected from the reference image, 2) if the system should continue to proceed using the same search area from the reference image, or 3) if the search area from the current image should be updated. In other embodiments, this process is automated and the system will automatically, default to one of the three scenarios.

If the shift is not too large, the offsets are saved and the shifted destination of the subsection is sent or stored to memory 525 and the program then returns to the beginning 526. The user will be alerted that a match within the tolerance could not be found between the data in the search area of the reference image and the data within the current image. The user can then decide 1) whether to select another search area from the reference image and then to re-perform the steps of the program on the same current image, 2) if the program should discard the current image and use the same search area from the reference image and select another image from the image file or from the live source and perform the comparison, or 3) the current image should be made into the reference image and the user should select a new search area from the new reference image prior to a comparison being made. If there is no match between the data from the reference image and from the current frame, the user of the program can discard the reference frame or the current frame and can begin the process again.

Thus, the process continues until all of the images are aligned or are discarded if no match is found. The images then may be displayed on a display device and motion of the images should be removed or minimized. Once the images have been readdressed, the images may be processed to produce a single higher resolution image from multiple lower resolution video images. The resolution can be increased because information in one image may not be contained in the other images; therefore this additional information increases the resolution.

In another embodiment of the invention, rather than making a comparison wherein an error value is calculated between the subsection of the reference image and the current image, a comparison can be made using a correlation function and determining the amount of correlation between the pixels from the two subsections. In all other respects, any of the proposed embodiments described above could be employed. As such, a region from the first image is selected and a region from the second image is selected and a correlation value is determined. Thus, the correlation value would be substituted for the error value and there would be a correlation threshold. A higher correlation value would be more indicative of correlation between the region from the first image and the region/shifted region of the second image.

The flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL.)

The present invention may be embodied in other specific forms without departing from the true scope of the invention. The described embodiments are to be considered in all respects only as illustrative and not restrictive.

1. A method for structuring digital video images, the digital video images each displayable on a display device relative to a reference point, the digital video images composed of a plurality of pixel data, the method comprising:
obtaining a first digital video image and a second digital video image;
selecting a region in the first digital image relative to the reference point and selecting a region in the second digital video image having the same location relative to the reference point as the region in the first digital image;
shifting in a direction, the region of the second digital video image; and
determining an error value based upon a comparison of data within the region from the first digital image and data within the shifted region from the second digital image.

2. The method according to claim 1, wherein if the error value is below a threshold,
readdressing the data of the second digital video image so that the data from the shifted region of the second digital video image is addressed to the same address as the data from the region of the first digital video image.

3. The method according to claim 1, the method further comprising:
normalizing the first and second digital video images.

4. The method according to claim 1, further comprising:
shifting in a second direction the region of the second digital video image;
determining a second error value based upon a comparison of data within the region from the first digital video image and data of the region of the second digital video image that has been shifted in the second direction;
comparing the first and second error values to determine the lower error value; and
in the second digital video image, selecting a new region shifted in the direction associated with the lower error value.

5. The method according to claim 1, wherein in the steps of shifting and determining are iteratively performed wherein the region of the second digital video image is shifted in one of the four cardinal directions during an iteration.

6. The method according to claim 1, wherein the steps of shifting and determining are iteratively performed such that the second digital video image is shifted in one of a plurality of directions during an iteration.

7. The method according to claim 5, further comprising:
comparing each of the error values; and
selecting a new region in the second digital video image in the direction associated with the error value having the lowest error.

8. The method according to claim 6, further comprising:
comparing each of the error values; and
selecting a new region in the second digital video image based upon the error value having lowest error value.

9. The method according to claim 7, further comprising:
comparing the lowest error value to a predetermined threshold value and when the lowest error value is less than the predetermined threshold value, repositioning at least the data of the current region of the second image so that if the data of the current region of the second image was displayed on a display device it would reside at the same location as that of the data from the region of the first image.

10. The method according to claim 8, further comprising:
comparing the lowest error value to a predetermined threshold value and when the lowest error value is less than the predetermined threshold value, repositioning at least the data from the current region of the second image so that if the data from the current region of the second image was displayed on a display device it would reside at the same location as the data from the region of the first image.

11. The method according to claim 4, further comprising:
comparing the lower error value to a predetermined threshold value;
if the lower error value is not below the predetermined threshold value, iteratively performing the steps of shifting, determining, comparing and selecting until the lower error value falls below the predetermined threshold value.

12. The method according to claim 4, further comprising:
comparing the lower error value to a predetermined threshold value;
if the lower error value is not below the predetermined threshold value iteratively performing the steps of shifting, determining, comparing and selecting until the lower error value falls below the predetermined threshold or the steps are performed a predetermined number of times.

13. The method according to claim 10, if the lower error value is not below a predetermined threshold value after the steps are performed a predetermined number of times, selecting a new region in the first image and performing the remaining steps with the new region of the first image.

14. A method for structuring digital video images, each digital video image composed of a plurality of pixels, each digital video image displayable on a display device with respect to a reference point, the method comprising:
selecting a first area in a reference image relative to the reference point and a first area in a second image having the same location relative to the reference point;
iteratively comparing the first area of the reference image to the first area of the second image plus a an expanded section of the second image wherein the expanded section changes between iterations;
calculating a difference between the first area of the reference frame and the first area of the second image plus the expanded section for each iteration;
based on the lowest difference, selecting a new area of the second image and performing the steps of iteratively comparing and calculating until the lowest difference is less than a predetermined value.

15. A method for structuring digital video images, each digital video image composed of a plurality of pixels, each digital video image displayable on a display device with respect to a reference point, the method comprising:
selecting an area in a reference image relative to the reference point and an area in a second image having the same location relative to the reference point;
iteratively and laterally shifting the location within the digital video image of the area within the second image;
calculating a difference between the area of the reference frame and the area of the second image for each iteration;
based on the lowest difference, selecting a new area of the second image and performing the steps of iteratively comparing and calculating.

16. The method according to claim 15, wherein the step of selecting a new area of the second image, the selected area is based on the direction of the lateral shift.

17. The method according to claim 16, wherein if the lowest difference falls below a predefined threshold, the second digital video image is repositioned such that the new area in the second image and the area in the first image overlap if the images were displayed on a display device.

18. A computer program product having a computer program on a computer readable medium for structuring digital video images, the digital video images each displayable on a display device relative to a reference point, the digital video images composed of a plurality of pixel data, the computer program comprising:
computer code for obtaining a first digital video image and a second digital video image;
computer code for selecting a region in the first digital image relative to the reference point and selecting a region in the second digital video image having the same location relative to the reference point as the region in the first digital image;
computer code for shifting in a direction the region of the second digital video image; and
computer code for determining an error value based upon a comparison of the data from the region of the first digital image and the data from the shifted region from the second digital image.

19. The computer program product according to claim 18, further comprising:
computer code for repositioning the data of the second digital video image in the direction that the second digital video image was shifted if the error value is below a threshold.

20. The computer program product according to claim 18, the computer code further comprising:
computer code for normalizing the first and second digital video images.

21. The computer program product according to claim 18, further comprising:
computer code for shifting in a second direction the region of the second digital video image;
computer code for determining a second error value based upon a comparison of the data from the region from the first digital image and the data from the shifted region of the second digital video image which has been shifted in the second direction; and
computer code for comparing the first and second error values to determine the lower error value; and
computer code for selecting a new region in the second digital video image shifted in the direction associated with the lower error value.

22. The computer program product according to claim 18, wherein in the computer code for shifting and determining are iteratively performed wherein the region of the second digital video image is shifted in one of the four cardinal directions during an iteration.

23. The computer program product according to claim 18, wherein the shifting and determining are iteratively performed such that the second digital video image is shifted in one of a plurality of directions during an iteration.

24. The computer program product according to claim 22, further comprising:
computer code for comparing each of the error values; and
computer code for selecting a new region in the second digital video image shifted with respect to the original region in the direction associated with the lowest error value.

25. The computer program product according to claim 23, further comprising:
computer code for comparing each of the error values; and
computer code for selecting a new region in the second digital video image shifted with respect to the original region in the direction associated with the lowest error value.

26. The computer program product according to claim 24, further comprising:
computer code for comparing the lowest error value to a predetermined threshold value and when the lowest error value is less than the predetermined threshold value, repositioning at least the data from the current region of the second image so that if the data from the current region of the second image was displayed on a display device it would reside at the same location as that of the data from the region of the first image.

27. The computer program product according to claim 25, further comprising:
computer code for comparing the lowest error value to a predetermined threshold value and when the lowest error value is less than the predetermined threshold value, repositioning at least the data from the current region of the second image so that if the data of the current region of the second image was displayed on a display device it would reside at the same location as that of the data of the region of the first image.

28. The computer program product according to claim 21, further comprising:
computer code for comparing the lower error value to a predetermined threshold value;
computer code for iteratively performing the steps of shifting, determining, comparing and selecting until the lower error value falls below the predetermined threshold value if the lower error value is not below the predetermined threshold value.

29. The computer program product according to claim 21, further comprising:
computer code for comparing the lower error value to a predetermined threshold value;
computer code for iteratively performing the steps of shifting, determining, comparing and selecting until the lower error value falls below the predetermined threshold or the steps are performed a predetermined number of times if the lower error value is not below the predetermined threshold value.

30. The computer program product according to claim 29, further comprising:
computer code for selecting a new region in the first image and performing the remaining steps with the new region in the first image if the lower error value is not below a predetermined threshold value after the steps are performed a predetermined number of times.

31. A computer program product having a computer readable program thereon for structuring digital video images, each digital video image composed of a plurality of pixels, each digital video image displayable on a display device with respect to a reference point, the computer program comprising:
computer code for selecting a first area in a reference image relative to the reference point and a first area in a second image having the same location relative to the reference point;
computer code for iteratively comparing the first area of the reference image to the first area of the second image plus a laterally augmented section of the second image wherein the laterally augmented section changes between iterations;
computer code for calculating a difference between the first area of the reference frame and the first area of the second image plus the laterally augmented section for each iteration;
computer code for selecting a new area of the second image based on the lowest difference and performing the steps of iteratively comparing and calculating until the lowest difference is less than a predetermined value.

32. A computer program product having computer readable code thereon for structuring digital video images, each digital video image composed of a plurality of pixels, each digital video image displayable on a display device with respect to a reference point, the computer code comprising:
computer code for selecting an area in a reference image relative to the reference point and an area in a second image having the same location relative to the reference point;
computer code for iteratively and laterally shifting the location within the digital video image of the area within the second image;
computer code for calculating a difference between the area of the reference frame and the area of the second image for each iteration;
computer code selecting a new area of the second image based on the lowest difference and performing the steps of iteratively comparing and calculating.

33. The computer program product according to claim 32, wherein in the computer code for selecting a new area of the second image, the selected area is based on the direction of the lateral shift.

34. The computer program product according to claim 32, wherein if the lowest difference falls below a predefined threshold, the second digital video image is repositioned such that the new area in the second image and the area in the first image overlap if the images were displayed on a display device.

35. A method for structuring digital video images, the digital video images each displayable on a display device relative to a reference point, the digital video images composed of a plurality of pixel data, the method comprising:
obtaining a first digital video image and a second digital video image;
selecting a region in the first digital image relative to the reference point and selecting a region in the second digital video image having the same location relative to the reference point as the region in the first digital image;
shifting in a direction, the region of the second digital video image; and
determining a correlation value based upon a comparison of data within the region from the first digital image and data within the shifted region from the second digital image.

36. A computer program product having a computer program on a computer readable medium for structuring digital video images, the digital video images each displayable on a display device relative to a reference point, the digital video images composed of a plurality of pixel data, the computer program comprising:
computer code for obtaining a first digital video image and a second digital video image;
computer code for selecting a region in the first digital image relative to the reference point and selecting a region in the second digital video image having the same location relative to the reference point as the region in the first digital image;
computer code for shifting in a direction the region of the second digital video image; and
computer code for determining a correlation value based upon the data from the region of the first digital image and the data from the shifted region from the second digital image.

37. The computer program product according to claim 36, further comprising:
computer code for repositioning the data of the second digital video image in the direction that the second digital video image was shifted if the data from the region of the second digital image and the data from the region of the first digital image are correlated above a correlation threshold.

38. The computer program product according to claim 36, the computer code further comprising:
computer code for normalizing the first and second digital video images.

39. The computer program product according to claim 36, further comprising:
computer code for shifting in a second direction the region of the second digital video image;
computer code for determining a second correlation value based upon the data from the region from the first digital image and the data from the shifted region of the second digital video image which has been shifted in the second direction; and
computer code for comparing the first and second correlation values to determine the correlation value having the greater correlation of data between the region of the first video image and the data of the shifted region of the second video image; and
computer code for selecting a new region in the second digital video image shifted in the direction associated with the correlation value having the greater correlation.

40. The computer program product according to claim 36, wherein in the computer code for shifting and determining are iteratively performed wherein the region of the second digital video image is shifted in one of the four cardinal directions during an iteration.

41. The computer program product according to claim 36, wherein the shifting and determining are iteratively performed such that the second digital video image is shifted in one of a plurality of directions during an iteration.

42. The computer program product according to claim 41, further comprising:
computer code for comparing each of the correlation values; and
computer code for selecting a new region in the second digital video image shifted with respect to the original region in the direction associated with the correlation value indicating the greatest correlation of data amongst the correlation values.

43. The computer program product according to claim 42, further comprising:
computer code for comparing each of the correlation values; and
computer code for selecting a new region in the second digital video image shifted with respect to the original region in the direction associated with the correlation value indicating the greatest correlation of data amongst the correlation values.

44. The computer program product according to claim 43, further comprising:
computer code for comparing the correlation value indicating the greatest correlation of data amongst the determined correlation values to a predetermined threshold value and when the correlation value indicating the greatest correlation of data amongst the determined correlation values is greater than the predetermined correlation threshold value, repositioning at least the data from the current region of the second image so that if the data from the current region of the second image was displayed on a display device it would reside at the same location as that of the data from the region of the first image.

45. The computer program product according to claim 44, further comprising:
computer code for comparing the correlation value indicating the greatest correlation of data amongst the determined correlation values to a predetermined threshold value and when the correlation value indicating the greatest correlation of data amongst the determined correlation values is greater than the predetermined correlation threshold value, repositioning at least the data from the current region of the second image so that if the data of the current region of the second image was displayed on a display device it would reside at the same location as that of the data of the region of the first image.

46. The computer program product according to claim 39, further comprising:
computer code for comparing the correlation value indicating the greatest correlation of data amongst the determined correlation values to a predetermined correlation threshold value;
computer code for iteratively performing the steps of shifting, determining, comparing and selecting until the correlation value indicating the greatest correlation of data amongst the determined correlation values is greater than the predetermined correlation threshold value.

47. The computer program product according to claim 39, further comprising:
computer code for comparing the correlation value indicating the greatest correlation of data amongst the determined correlation values to a predetermined correlation threshold value;
computer code for iteratively performing the steps of shifting, determining, comparing and selecting until the correlation value indicating the greatest correlation of data amongst the determined correlation values is greater than the predetermined correlation threshold value or the steps are performed a predetermined number of times if the correlation value is never greater than the threshold correlation value.

48. The computer program product according to claim 47, further comprising:
computer code for selecting a new region in the first image and performing the remaining steps with the new region in the first image if the correlation value is not greater than the threshold correlation value after the steps are performed a predetermined number of times.
